(19) United States
(12) Patent Application Publication
(10) Pub. No.: US 2014/0202266 A1
(43) Pub. Date: Jul. 24, 2014

(54) MATERIAL SAMPLING DEVICE

(71) Applicants: Ivan Banga, Glen Carbon, IL (US); Ronald Lee Nash, Florissant, MO (US)

(72) Inventors: Ivan Banga, Glen Carbon, IL (US); Ronald Lee Nash, Florissant, MO (US)

(21) Appl. No.: 14/130,560

(22) PCT Filed: Jun. 29, 2012
(86) PCT No.: PCT/US12/44861

§ 371 Date: Mar. 6, 2014

Related U.S. Application Data
(60) Provisional application No. 61/571,785, filed on Jul. 5, 2011.

(51) Int. Cl. G01N 1/08

(52) U.S. Cl. CPC G01N 1/08
USPC 73/864.43

(57) ABSTRACT

The invention provides material sampling devices and methods of using the material sampling devices. In a general aspect, the material sampling device includes a material sampling device including a rotator, an auger, and a sample containment tube. The rotator includes a rotating mechanism. The auger is attached to and rotatable by the rotating mechanism. A sample containment tube is constructed and arranged to receive the auger. The invention also provides kits useful for making the material sampling devices and using such material sampling devices for collecting and evaluating samples of a material.

This application claims priority to U.S. Provisional Application Ser. No. 61/571,785 filed Jul. 5, 2011, the disclosure of which is incorporated herein by this reference.

### BACKGROUND OF THE INVENTION

1. Field of the Invention

The invention relates generally to material sampling devices and particularly to material sampling devices and methods useful for obtaining samples of products with poor flow characteristics.

2. Description of Related Art

Representative collecting and sampling is critical to facilitate the evaluation of inbound raw materials. Sampling of raw materials is currently performed using the following equipment: a manual probe or tier and pneumatic sampling systems. Conventional sampling probes for non-free flowing material (e.g., rendered animal meals, soybean meal, corn gluten meal, cereal flours, wheat gluten, etc.) are small and are turned manually. They cannot be used for bulk sampling (e.g., silos, large bins, railcars, or truck hoppers).

Generally, conventional manual probes do not effectively obtain a representative sample and are difficult to use. Conventional manual probes are not designed to work with ingredients that possess poor flow characteristics. Moreover, reliable sampling using conventional manual probes may not be assured for a variety of reasons. For example, the manual force required to push the probe through the raw materials is typically greater than an average person can apply (not complete cross section sample). In addition, raw materials will not sufficiently flow into the probe. Instead, the probe has a tendency to create a “tunnel” within the raw materials.

The inconsistencies of sampling raw material prove laborious and time consuming for obtaining and discharging raw materials. Additionally, routine maintenance and cleaning of sampling equipment is unnecessarily challenging.

### SUMMARY OF THE INVENTION

It is, therefore, an object of the invention to provide material sampling devices for collecting raw material.

It is another object of the invention to provide methods of collecting a sample of a material using a material sampling device.

It is still another object of the invention to provide kits having devices and instructions for sampling raw materials.

It is another object of the invention to provide packages and indicia describing the contents of the package including a material sampling device.

These and other objects are achieved using a material sampling device including a rotator, an auger, and a sample containment tube. The rotator includes a rotating mechanism. The auger is attached to and rotatable by the rotating mechanism. A sample containment tube is constructed and arranged to receive the auger. The material sampling device can be used to effectively collect representative samples of a raw material such as non-free flowing granulated or powdered material. The time required to obtain the sample, as well as the overall integrity of the sample, using the material sampling device is improved upon over conventional manual probes.

Additional and further objects, features, and advantages of the invention will be readily apparent to those skilled in the art.

### BRIEF DESCRIPTION OF THE DRAWINGS

FIG. 1 shows a perspective view of an auger attached to a rotator of a material sampling device in an embodiment of the invention.

FIG. 2 shows a perspective view of a sample containment tube attached to the rotator of the material sampling device in an embodiment of the invention.

### DETAILED DESCRIPTION OF THE INVENTION

### Definitions

The term “rotator” means a device constructed and arranged for rotating an auger. In an embodiment of the present invention, the rotator is in the form of a “hand drill” configuration having an electric motor that turns an auger. Any other suitable devices (e.g., wheel, crank handle, robotic arm, etc.) or means (e.g., electric, air, hydraulic, manual, etc.) for turning the auger can be used as the rotator in alternative embodiments of the invention.

The term “auger” means a helical screw blade that acts as a screw conveyor which moves material on its blade as the auger is rotated in one direction. If the auger is rotated in the opposite direct, material is removed from the blade. The auger can be made from any suitable strong and durable material such as steel.

The term “single package” means that the components of a kit are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may contain a rotator, an auger, a sample containment tube, and the like as described herein that can be physically associated such that they are considered a unit for manufacture, distribution, sale, or use.

The term “virtual package” means that the components of a kit are associated by directions on one or more physical or virtual kit components instructing the user how to obtain the other components, e.g., a bag or other container containing one component and directions instructing the user to go to a website, contact a recorded message or a fax-back service, view a visual message, or contact an instructor to obtain instructions on how to use the kit or safety or technical information about one or more components of a kit.

As used herein and in the appended claims, the singular form of a word includes the plural, and vice versa, unless the context clearly dictates otherwise. Thus, the references “a”, “an”, and “the” are generally inclusive of the plurals of the respective terms. For example, reference to “a material sampling device” or “a method” includes a plurality of such “material sampling devices” or “methods”. Similarly, the words “comprise”, “comprises”, and “comprising” are to be interpreted inclusively rather than exclusively. Likewise, the terms “include”, “including” and “or” should all be construed to be inclusive, unless such a construction is clearly prohibited from the context. Where used herein the term “examples,” particularly when followed by a listing of terms is merely exemplary and illustrative, and should not be deemed to be exclusive or comprehensive.

The devices, assemblies, kits, methods, compositions and other advances disclosed here are not limited to particular methodology, protocols and reagents described herein because, as the skilled artisan will appreciate, they may vary. Further, the terminology used herein is for the purpose of describing particular embodiments only, and is not intended to, and does not, limit the scope of that which is disclosed or claimed.

### The Invention

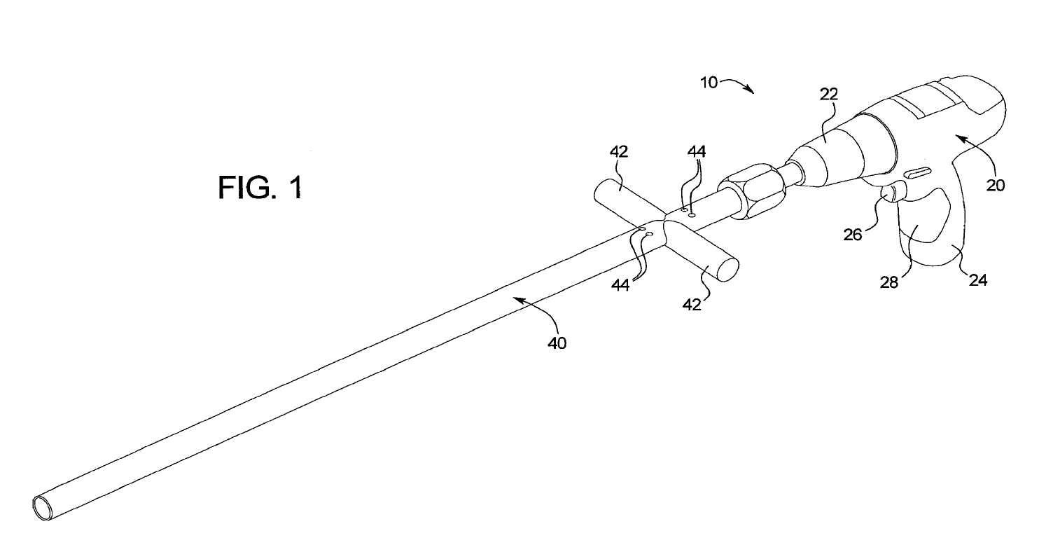

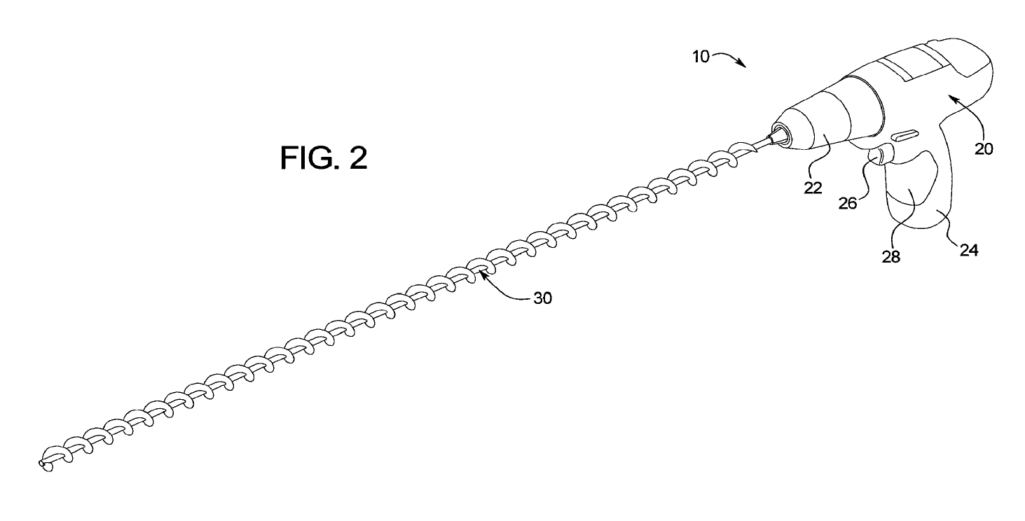

In one aspect illustrated in FIGS. 1-2, the invention provides a material sampling device 10 including a rotator 20 having a rotating mechanism 22, an auger 30 attached to and rotatable by rotating mechanism 22, and a sample containment tube 40 constructed and arranged to receive auger 30. For example, auger 30 is insertable into sample containment tube 40 as shown by FIG. 1.

In an embodiment, rotator 20 can be a battery powered (e.g., cordless) hand drill including a handle 24 having a trigger 26 to allow a user to grip rotator 20 and operate auger 30 by pressing trigger 26. Handle 24 can be any suitable configuration and include any suitable textured grip 28 allowing it to be easily grasped by a user. Rotating mechanism 22 can include any suitable attachment mechanism so as to allow auger 30 to be firmly attached to rotating mechanism 22. Rotating mechanism 22 can also include any suitable motor or device capable of rotating auger 30. Rotator 20 can include any suitable switching component (e.g., reverse button) for controlling the rotation direction of rotating mechanism 22.

At one end, auger 30 is attached to rotating mechanism 22 of rotator 20. The opposite end of auger 30 is not affixed to anything and extends to the open end of sample containment tube 40. When powered by rotator 20, auger 30 can rotate in both directions (e.g., clockwise and counterclockwise) within sample containment tube 40. At the same time during operation, sample containment tube 40 is firmly or fixedly attached to rotator 20 and does not rotate. Sample containment tube 40 can be easily removed or detached from rotator 20 to expose auger 30 for cleaning. This also allows the inside of sample containment tube 40 to be accessed for ease of cleaning.

In an embodiment, sample containment tube 40 includes one or more one handles 42 on either side of sample containment tube 40 in which a user can grip for ergonomic and positioning purposes. Sample containment tube 40 can further include one or more apertures 44. When the material reaches the top or end of sample containment tube 40, apertures 44 can be used to visibly inform the user that material sampling device 10 has successfully obtained a sample of the material (e.g., sample containment tube 40 is entirely filled with material). Apertures 44 can also be used to prevent pressure build-up within sample containment tube 40 as sample is collected inside via auger 30.

Sample containment tube 40 can have the shape of an elongated cylinder and be any suitable length. It should be appreciated that sample containment tube 40 should have a peripheral/cross-sectional shape that corresponds to auger 30 to maximize the effectiveness of collecting samples of materials in sample containment tube 40. Preferably, sample containment tube 40 should have a length that is about the same as a depth of a bed or pile of material to be sampled. Sample containment tube 40 can be made from any suitable material, for example, such as a rigid metal (e.g., aluminum) or plastic.

In an embodiment, material sampling device 10 works as follows. The end of sample containment tube 40 opposite of rotator 20 is placed onto a bed or pile of material such as powdered ingredients. Clockwise rotation of auger 20 is caused by pressing trigger 26 of rotator 20. Auger's 20 rotation pulls auger 20 with its corresponding sample containment tube 40 into the material. After reaching a desired depth or the bottom of the material, 20 rotation of auger 20 is stopped by releasing trigger 26. Material sample device 10 is pulled out of the material bed along with a “captured” or core sample of material held within sample containment tube 40. The captured core sample of material can be expelled from sample containment tube 40 by rotating auger 30 in the counter-clockwise direction.

Material sampling device 10 advantageously provides a number benefits that cannot be found in conventional sampling probes. These benefits include: 1) the ability to probe the full-depth of ingredients from truck trailers and rail cars, 2) the ability to capture ingredient samples from the bottom of trucks and rail cars, 3) the ability to obtain top-to-bottom sample volumes from truck trailers and rail cars, 4) reducing the physical difficulties of trying to manually force probes deeper into ingredients, and 5) reducing the difficulties of accessing a probe's internal surfaces for cleaning purposes. By being able to effectively and efficiently test and evaluate any type of material, the material sampling device can further improve reduce of prevent the receipt of incorrect materials and contaminated raw materials.

In an alternative aspect, the invention provides a method of collecting a sample of a material. The method includes providing a material sampling device including a rotator having a rotating mechanism, an auger attached to and rotatable by the rotating mechanism, and a sample containment tube surrounding the auger; inserting the sample containment tube into the material; and rotating the auger to collect samples of the material in the sample containment tube.

The sample material collected by the material sampling device can be any material compatible with the material sampling device. In certain embodiments, the material has poor flow characteristics. Materials with poor flow characteristics typically have adhesive properties that cause the particles to adhere to each other or have properties that create excess friction between the particles as they flow and impede the free or easy flow of the particles. Such friction can be caused by many factors, e.g., lack of particle uniformity; particle shape; and particle stickiness caused by particle ingredients such as sugars, starches, fats or by moisture. The material sampling device is particularly useful for collecting samples of materials with poor flow characteristics.

Once a sufficient amount of sample has been collected, the sample can be removed from the sample containment tube by rotating the auger (e.g., in an opposition direction from collecting) to release the material from the sample containment tube. The material from the sample containment tube can be released into a bucket or any suitable container. The collected sample can be evaluated to determine whether the sample meets quality standards. The collected sample can also be evaluated to determine whether the sample has specific or desired physical or chemical characteristics.

The material that is collected or sampled can be any suitable raw material. The material can be in any form such as a powder, particulates, pellets, granules, or combinations thereof. The material can be free-flowing or sticky. The material sampling device can advantageously be used for powder-type ingredients, e.g., used for wheat gluten to reduce manpower requirement per sample by approximately 50%.

In an alternative aspect, the invention provides kits useful for collecting samples and using the material sampling devices of the invention. The kits include in separate containers in a single package or in separate containers in a virtual package, as appropriate for the kit component, either (A) material sampling device including a rotator having a rotating mechanism, an auger attachable to and rotatable by the rotating mechanism, and a sample containment tube constructed and arranged to receive the auger; or (B) a rotator having a rotating mechanism, and at least one of (1) an auger attachable to and rotatable by the rotating mechanism; (2) a sample containment tube constructed and arranged to receive the auger; (3) instructions on how to use the material sampling device for collecting material samples; (4) instructions on how to clean the material sampling device; or (5) product specifications for materials that can be collected by the material sampling device.

When the kits comprise a virtual package, the kits are limited to instructions in a virtual environment in combination with one or more physical kit components. The kits may contain the kit components in any of various combinations. In one embodiment, the kit contains a rotator having a rotating mechanism and an auger attachable to and rotatable by the rotating mechanism. In this embodiment, one or more sample containment tubes associated with the constructed and arranged to receive the auger can be sold with this kit or sold separately from the kit, for example, as part of a virtual kit.

The kits can encompass one or more kit components that are ordered and shipped separately to a consumer, e.g., an order on the internet or by phone for a rotator and a sample containment tube wherein the two articles are shipped from separate locations to the consumer's address. In all embodiments, the rotator, the auger, and the sample containment tube may be attachable and detachable so that they can be used to produce a material sampling device of the invention.

In a further aspect, the invention provides a means for communicating information about or instructions for one or more of (1) assembling the rotator, the auger, and the sample containment tube to produce the material sampling device; (2) using the material sampling device collect a sample of a raw material; (3) using the material sampling device to collect a sample of any suitable material; or (4) cleaning the material sampling device.

The communication means can be a document, digital storage media, optical storage media, audio presentation, or visual display containing the information or instructions. In certain embodiments, the communication means can be a displayed website, a visual display kiosk, a brochure, a product label, a package insert, an advertisement, a handout, a public announcement, an audiotape, a videotape, digital streaming, a DVD, a CD-ROM, a computer readable chip, a computer readable card, a computer readable disk, a USB device, a FireWire device, a computer memory, and any combination thereof.

Useful information includes one or more of contact information for consumers to use if they have a question about the invention and its use. The communication means is useful for instructing on the benefits of using the present invention and communicating the approved methods for using the invention for the collecting and evaluating samples of raw materials using the material sampling device.

In another aspect, the invention provides a package including indicia describing a material sampling device including a rotator having a rotating mechanism, an auger attached to and rotatable by the rotating mechanism, and a sample containment tube constructed and arranged to receive the auger. The indicia can be in the form of words, symbols, pictures, photographs, figures, or combinations thereof to show details or examples of the material sampling device described herein. The package further contain a material sampling device including a rotator having a rotating mechanism, an auger attached to and rotatable by the rotating mechanism, and a sample containment tube constructed and arranged to receive the auger.

In an embodiment, the package can include one or more handles suitable for handling and transporting the package. The package can include one or more windows for viewing the material sampling device or any parts thereof. The package can include a label affixed to the package containing a word or words, picture, design, acronym, slogan, phrase, or combination thereof, that indicates that the package contains a material sampling device including a rotator having a rotating mechanism, an auger attached to and rotatable by the rotating mechanism, and a sample containment tube constructed and arranged to receive the auger.

All patents, patent applications, publications, and other references cited or referred to herein are incorporated herein by reference to the extent allowed by law. The discussion of those references is intended merely to summarize the assertions made therein. No admission is made that any such patents, patent applications, publications or references, or any portion thereof, are relevant prior art for the present invention and the right to challenge the accuracy and pertinence of such patents, patent applications, publications, and other references is specifically reserved.

What is claimed is:

1. A material sampling device comprising:
a rotator having a rotating mechanism;
an auger attached to and rotatable by the rotating mechanism; and
a sample containment tube constructed and arranged to receive the auger.

2. The material sampling device of claim 1 wherein the rotator is an electric-powered hand drill.

3. The material sampling device of claim 1 wherein the hand drill is rechargeable.

4. The material sampling device of claim 1 wherein the auger is insertable into the sample containment tube.

5. The material sampling device of claim 1 wherein the sample containment tube includes at least one handle.

6. The material sampling device of claim 1 wherein the sample containment tube includes at least one aperture.

7. The material sampling device of claim 1 wherein the rotator includes a handle having a trigger.

8. The material sampling device of claim 7 wherein the handle includes a textured grip.

9. A method of collecting a sample of a material comprising:
providing a material sampling device comprising a rotator having a rotating mechanism, an auger attached to and rotatable by the rotating mechanism, and a sample containment tube surrounding the auger;
inserting the sample containment tube into the material; and
rotating the auger to collect samples of the material in the sample containment tube.

10. The method of claim 9 comprising removing the sample containment tube from the material and rotating the auger to release the material from the sample containment tube.

11. The method of claim 9 comprising evaluating the sample to determine whether the sample meets quality standards.

12. The method of claim 9 comprising evaluating the sample to determine whether the sample has specific characteristics.

13. The method of claim 9 wherein the material is a raw material.

14. The method of claim 9 wherein the material is in a form selected from the group consisting of powder, particulates, pellets, granules, and combinations thereof.

15. The method of claim 9 wherein the material has poor flow characteristics.

16. (canceled)

17. (canceled)

18. (canceled)

19. (canceled)

20. (canceled)

21. (canceled)

22. (canceled)

23. (canceled)

24. (canceled)

25. (canceled)

26. (canceled)
